(19) United States
(12) Patent Application Publication
(10) Pub. No.: US 2018/0164255 A1
(43) Pub. Date: Jun. 14, 2018

(54) ADJUSTABLE WIDE BANDWIDTH GUIDEWAVE (GW) PROBE FOR TUBE AND PIPE INSPECTION SYSTEMS

(71) Applicant: ARISE GLOBAL PTE LTD., Singapore (SG)

(72) Inventors: Eyal Conforti, Tel Aviv (IL); Peter Sirkis, Tel Aviv (IL); Dov Furman, Tel Aviv (US)

(21) Appl. No.: 15/577,699

(22) PCT Filed: Jun. 27, 2016
(86) PCT No.: PCT/IL2016/050682

§ 371 Date: Nov. 28, 2017

Related U.S. Application Data
(60) Provisional application No. 62/181,188, filed on Jun. 17, 2015.

(51) Int. Cl. G01N 29/24; G01N 29/265; G01N 29/04; G01N 29/22

(52) U.S. Cl. CPC G01N 29/24; G01N 29/265; G01N 2291/106; G01N 29/226; G01N 2291/2636; G01N 29/043

(57) ABSTRACT

The present disclosure relates to the field of non-destructive testing and more particularly, the present disclosure is in the technical field of tube and pipe inspection. Disclosing a hand-held probe (HHP) for inspecting a tube, comprising: a transducer cylinder having a shape of a cylinder with a near end and a far end and comprises one or more rings of transducers (TRs), wherein each TR comprises two or more mechanical wave transducers where the diameter of the transducer cylinder is less than the internal diameter of the tube; and a housing having an opening for receiving a near end of the transducer cylinder, the end opposite from the tube end that is inserted into the tube. The transducer cylinder comprises an adjustable centering mechanism (ACM) that is configured to join substantially a central axis of the transducer cylinder with a central axis of the inspected tube when the transducer cylinder is inside one end of the inspected tube.

### CROSS-REFERENCE TO RELATED APPLICATIONS

The present application is related to US patent application number U.S. Ser. No. 14/641,418 that claims priority to the U.S. provisional patent application Ser. No. 61/950,158 filed on Mar. 9, 2014 and is related to a Patent Cooperation Treaty application (PCT) application number PCT/IL2013/000054 that was filed in the Israeli Receiving Office on Jun. 10, 2013, the contents of each of these are incorporated herein by reference.

### FIELD OF INVENTION

The present disclosure relates to the field of non-destructive testing and more particularly, the present disclosure is in the technical field of tube and pipe inspection.

### DESCRIPTION OF BACKGROUND ART

There are several techniques, presently in use, for conducting tube or pipe inspections. These techniques can be divided into two main groups: traversing and non-traversing. The traversing methods employ a probe, which can inspect only the portion of the tube in its immediate vicinity. In order to inspect an entire tube, the probe is tethered to a cable by which the probe is pushed all the way down from one end of the tube to the other and then pulled back. Traversing methods are slow, prone to wear and tear of the probe, and eventual failure. One example of a traversing inspection method is Eddy Current Testing, and related methods such as Remote Field Testing and Magnetic Flux Leakage testing. All these traversing methods are electromagnetic methods, having varying degrees of accuracy. Another example is the widely known as IRIS (Internal Rotating Inspection System), which is based on ultrasound. IRIS is based on use of a probe that scans the tube wall in a spiral manner using an ultrasound beam propagating in water. It is much slower than the electromagnetic methods and requires cleaning the tube wall down to the metal, which is an expensive process. Throughout this disclosure, the terms tube and pipe can be used interchangeably and the term tube can be used as representative term for both terms.

Non-traversing methods are based on inserting a probe a relatively short distance into a tube under test, and then applying a physical method for inspecting the entire tube from this location. As a non-limiting example of such a method is Acoustic Pulse Reflectometry (APR). In the APR method, an acoustic signal (which could be, for example, but not limited to a pulse or a pseudo noise signal, swept sine, etc.) is propagated through the air inside the tube. Any changes in the cross sectional profile of the tube creates reflections, which propagate back down to the probe where they can be recorded and later analyzed. APR gives good results in detecting anomalies on the interior surface or cross-sectional profile of a tube, such as blockages, through holes, and circumferential changes in cross section of a tube. APR has several advantages: APR is fast, it can accurately assess blockages, and it is very sensitive to through-holes, for example. A reader who wishes to learn more about APR systems is invited to read U.S. Pat. No. 7,677,103, or US pre-granted publication number US2011-0166808, or U.S. Pat. No. 8,960,007.

An inspection method, which is known widely as the Guided-Wave (GW) method, is based on propagating mechanical waves within the tube wall itself. These waves can be, for example but not limited to, a torsional or longitudinal or flexural wave, and the excitation signal can be for example, but not limited to, a pulse or a pseudo noise signal, swept sine, etc. The torsional waves are marked with the letter ‘T’; the longitudinal waves are marked with the letter ‘L’; the flexural waves are marked with the letter ‘F’. Torsional waves are those in which particle displacement is in the circumferential direction, but the wave propagates down the axis of the tube. Longitudinal waves are those in which the particle displacement is in the axial direction, similarly to the direction of propagation of the wave. Particle displacement in torsional waves and longitudinal waves is independent of the azimuthal angle, therefore they are axisymmetric. Each type of the above waves are associated with:
An infinite number of higher order axisymmetric modes, depending on the number of nodal surfaces through the thickness of the tube wall, denoted T(0,m), m=1,2,3, . . . for torsional modes and L(0,m), m=1,2,3 . . . for longitudinal modes; These modes have different cut-on frequencies and different dispersion curves.
A doubly infinite number of non-axisymmetric modes, denoted F_{T}(n,m)—where n=1,2,3 . . . and m=1,2,3 . . . for flexural modes associated with torsional waves, and F_{L}(n,m)—where n=1,2,3 . . . and m=1,2,3 . . . for flexural modes associated with longitudinal waves. These modes have different cut-on frequencies and different dispersion curves.

Different modes of excitation are well known to a person having ordinary skill in the art and will not be further described. A reader who wishes to learn more about mechanical waves is invited to read technical documents such as but not limited to the article “Flexural torsional guided wave mechanics and focusing in pipe”, Journal of Pressure Vessel Technology Vol. 127, November 2005, pp. 471-478 written by Zongqi Sun, Li Zhang, Joseph L. Rose, for example.

Interfacing to the tube can be done from the interior of the tube by inserting a GW probe with one or more GW transducers in one of the openings of the tube. Alternatively the interfacing can be done from the external side of the tube by associating one or more GW transducers with the outer circumference of the tube.

The GW technique is sensitive to the degree of material loss. Any changes in the tube wall properties or dimensions will create a reflection, which can be recorded and analyzed. GW is fast and sensitive to flaws on both the outside and inside surfaces of the tube. Typically GW inspection systems have limited bandwidth (BW).

### SUMMARY OF THE DISCLOSURE

In order to detect small defects, excitation of high frequencies having short wavelengths is needed. For example, mechanical waves with frequencies above 200 KHz may be needed in order to detect defects of length 2-3 millimeters. Further, in order to achieve high resolution and accurate sizing GW systems need to be broadband from low frequencies up to high frequencies, for example from 20 kHz up to 400 kHz. One of the challenges in obtaining large bandwidth is in exciting only the desired modes. However, the scattering caused by defects excites many unwanted modes. Therefore another challenge in achieving a large bandwidth is to filter out these unwanted modes. Some embodiments of the present disclosure achieve large bandwidth by precise location of the transducers on the circumference of the tube.

It is well known to a person with ordinary skill in the art that exciting mechanical waves in tubes is associated with excitation of a plurality of modes such as T, L and F_{L} and F_{T} etc. Some of these modes interfere with the desired measurement and are therefore termed “unwanted modes”. The unwanted modes may be generated in the inspected tube in addition to the wanted modes.

For example in order to use mode T(0,1) as the wanted mode, an embodiment of the system can transmit substantially the same signal simultaneously from all transducers on a ring of N transducers. The transducers can be distributed substantially evenly on the circumference. However, in such a case, a plurality of unwanted modes will be excited. The dominant unwanted modes interfering with the measurement may include: F_{T}(N,1); F_{T}(2N,1) . . . ; F_{L}(N,1); F_{L}(2N,1); . . . ; etc. For example, using six transducers on each ring can excite unwanted modes F_{T} (6,1), F_{L}(6,1), F_{T}(12,1), F_{L}(12,1), T(0,2), F_{L}(6,2), . . . etc. If these modes are not suppressed relatively to the wanted signal, the interpretation of the measured signal will be ambiguous and defects may be masked. The cut-on frequency of these unwanted modes is generally monotonic with the index ‘N’ given above. In the present disclosure and the claims the terms measure, inspect, monitor, test, check, etc. can be used interchangeably.

In other embodiments other modes can be used as the wanted modes. For example in order to use mode F_{T} (1,1) as the wanted mode an embodiment of the system can transmit weighted versions of substantially the same signal simultaneously from all transducers on a ring of N transducers. The weights can be sin(2πk/N) where k is the transducer index along the circumference, and can be equal to k=0,1 . . . N−1. For example, using six transducers on each ring can excite unwanted modes F_{T} (5,1), F_{T} (7,1), F_{L}(5,1), F_{L}(7,1), . . . etc. In a similar way, other embodiments may select other modes as the wanted mode.

Therefore, for the cut-on frequencies of the unwanted modes to be beyond the desired bandwidth's upper limit, a large number of transducers (N) is needed. Thus, it increases the available spectral bandwidth without unwanted modes. Consequently, one technique to avoid the presence of these modes in the desired frequency band, can involve increasing the number of transducers around the tube circumference. When inspecting narrow gauge tubes, such as those typically found in heat exchangers, it is difficult to fit a sufficient number of transducers into the limited space available. In addition, the cost of the transducers may also play a role for wide gauge pipes.

In addition to having a large number of transducers, an example embodiment of GW probe is configured to place each one of the transducer at precise locations circumferentially in relation to the other transducers. In some embodiments of GW probes, the GW transducers are placed at equidistant locations around the circumference. Embodiments of a GW probe may comprise a mechanism that enables rapid pressing of the GW transducers against the tube wall and then rapid release, while ensuring that the GW transducers are placed as precisely as possible.

Some embodiments of the GW probe are configured to place both ends of the assembly containing the GW transducers concentric within the tube being inspected. Further, embodiments of GW probe are configured to enforce the movement of the transducers, within the probe, only in the radial direction, creating a substantially concentric circle with the tube.

Some example embodiments of the novel GW probe are configured to support the weight of the elements that remain out of the tube also, so that despite any torque those elements apply on the assembly internal to the tube, the placement of the sensors will be affected as little as possible.

The above-described deficiencies of GW methods, do not limit the scope of the inventive concepts of the present disclosure in any manner. The deficiencies are presented for illustration only.

In the following description, for purposes of explanation, numerous specific details are set forth to assist in the understanding of the various embodiments and aspects of inventions presented within this document. It will be apparent, however, to one skilled in the art that embodiments of the invention may be practiced without some or all of these specific details. In other instances, structures and devices are shown in block diagram form to avoid obscuring the flexibility and variability of the embodiments of the invention. References to numbers without subscripts or suffixes are understood to reference all instances of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter.

Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments may implement the features and functionality described herein in software, firmware, or hardware as desired, including any combination of software, firmware, and hardware. In the following description, the words “unit,” “element,” “module” and “logical module” may be used interchangeably. Anything designated as a unit or module may be a stand-alone unit or a specialized or integrated module. A unit or a module may be modular or have modular aspects allowing it to be easily removed and replaced with another similar unit or module. Each unit or module may be any one of, or any combination of, software, hardware, and/or firmware, ultimately resulting in one or more processors programmed to execute the functionality ascribed to the unit or module. Additionally, multiple modules of the same or different types may be implemented by a single processor. Software of a logical module may be embodied on a computer readable medium such as a read/write hard disc, CDROM, Flash memory, ROM, or other memory or storage, etc. In order to execute a certain task a software program may be loaded to an appropriate processor as needed. In the present disclosure the terms task, method, process can be used interchangeably.

These and other aspects of the disclosure will be apparent in view of the attached figures and detailed description. The foregoing summary is not intended to summarize each potential embodiment or every aspect of the present disclosure, and other features and advantages of the present disclosure will become apparent upon reading the following detailed description of the embodiments with the accompanying drawings and appended claims.

Furthermore, although specific exemplary embodiments are described in detail to illustrate the inventive concepts to a person skilled in the art, such embodiments are susceptible to various modifications and alternative forms. Accordingly, the figures and written description are not intended to limit the scope of the inventive concepts in any manner.

### BRIEF DESCRIPTION OF THE DRAWINGS

Some examples of embodiments of the present disclosure will be understood and appreciated more fully from the following detailed description, taken in conjunction with the drawings in which:

FIG. 1A illustrates a front end of an example of hand-held probe (HHP) associated with a transducer cylinder (TC) that comprises a centering mechanism;

FIG. 1B shows a side view of an example of a conical-centering mechanism (CCM) that comprises one or more stepwise-conical elements;

FIG. 1C shows a cross section view of the CCM of FIG. 1B;

FIGS. 2A&B illustrates two states of an adjustable centering mechanism (ACM) 200 for centering a transducer cylinder 210. The ACM 200 can be located at the far end of the transducer cylinder 210;

FIGS. 3A&B, illustrate example elements of a transducer cylinder (TC) 300 having two virtual rings (VR) of GW transducers, wherein the VRs are at a first state and wherein each VR is associated with another example of an ACM;

FIGS. 4A&B, show example elements of the TC 300 of FIGS. 3A&B, wherein the VRs are at a second state;

FIG. 5 shows relevant elements of an example of a GW tube inspection system; and

FIG. 6, show a flowchart with relevant actions of an example process for attaching-detaching process of an example of HHP with a tube.

### DETAILED DESCRIPTION OF DIFFERENT EMBODIMENTS

Turning now to the figures in which like numerals represent like elements throughout the several views, different embodiments of a tube inspection system, as well as features, aspects and functions that may be incorporated into one or more such embodiments, are described. For convenience, only some elements of the same group may be labeled with numerals. The purpose of the drawings is to describe different embodiments and not for production. Therefore, features shown in the figures are chosen for convenience and clarity of presentation only. It should be noted that the figures are for illustration purposes only and are not necessarily drawn to scale. Moreover, the language used in this disclosure has been principally selected for readability and instructional purposes, and may not have been selected to delineate or circumscribe the inventive subject matter, resort to the claims being necessary to determine such inventive subject matter.

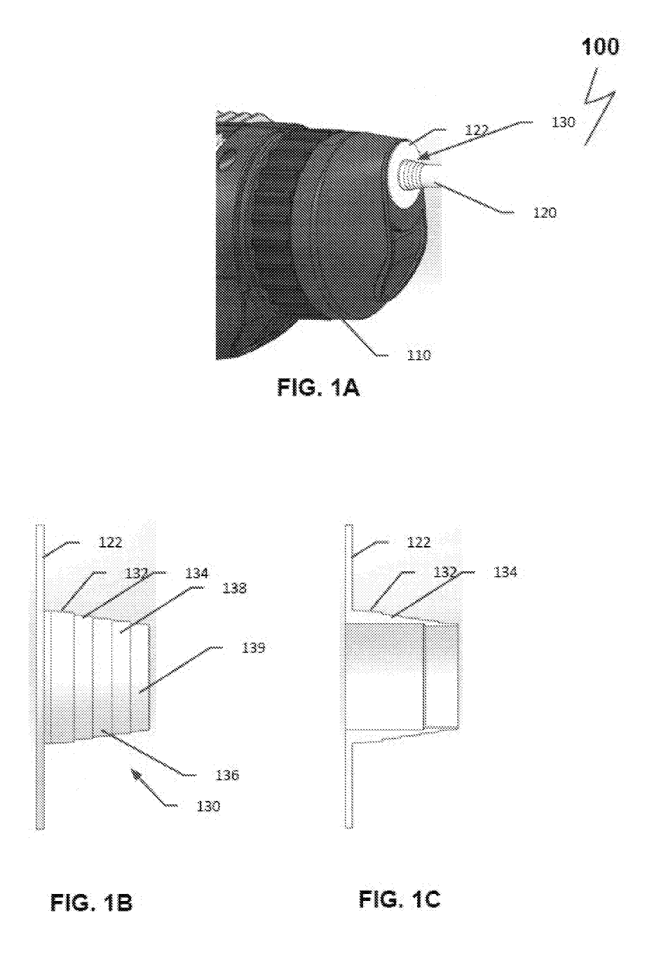

FIG. 1A shows perspective of a front end of an example of hand-held probe (HHP) 110 associated with a transducer cylinder (TC) 120 that comprises a conical-centering mechanism (CCM) 130. The illustrated example of the CCM 130 comprises one or more stepwise conical elements 132, 134, 136, 138 & 139 (FIGS. 1B&C) at the near end 122 of the TC 120 that is attached to the body 110 of the HHP 120.

In order to associate the HHP 110 with a tube, the TC 120 may be pushed into the tube up to one of the conical elements 132, 134, 136, 138 & 139 (FIGS. 1B&C), this one conical element can be referred as the matched-conical element (MCE). The outer diameter of the MCE can be substantially similar to inner diameter of the opening of the tube. The conical structure of each of the relevant element forces the TC 120 to be concentric with in the tube. Thus, the number of steps 132, 134, 136, 138 & 139 (FIGS. 1B&C) and the conical shape of each step give a degree of freedom that enables a single TC 120 to inspect tubes having different diameters.

The angle of each segment 132, 134, 136, 138 & 139 (FIGS. 1B&C) is such that given the material of this element, and that of tube being inspected, and the coefficient of friction between them, when the probe is inserted into the tube, the friction will hold it stationary even if the hand held unit is left to hang on its own weight.

In some embodiments of HHP 100 the TC 120 can be permanently affixed to the HHP 100. In other embodiments of HHP 100 the TC 120 can be detachably affixed. The hand-held probe 100 can include or be coupled with a plurality of different sizes of transducer cylinders 120, wherein each transducer cylinder could fit a different internal diameter of an inspected tube.

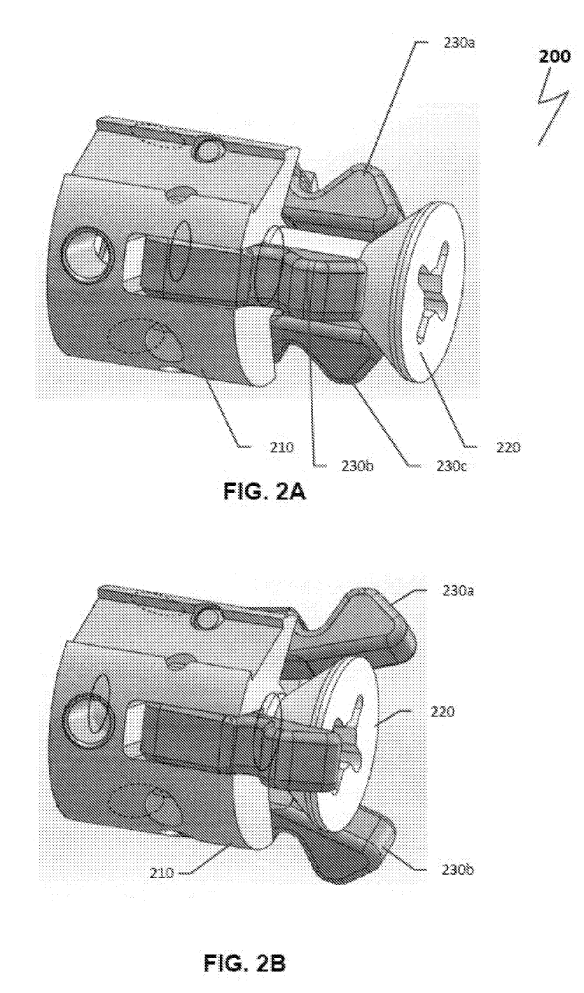

FIGS. 2A&B shows an example of a centering mechanism 200 located at the far end of the TC 210. Three guides 230a,b&c with rounded surfaces facing out from the probe, towards the inner surface of a tested tube, maintain the far end of the probe concentric with the tube. The centering mechanism 200 is adjustable by a pushing screw 220. The pushing screw 220 can be configured to push, while it is rotated clockwise, the guides 230a,b&c out to the required distance, as it is illustrated by FIG. 2B. While the screw 220 is rotated counterclockwise the guides 230a,b&c can return to the center of probe 210 as in FIG. 2A.

The angle and the material of the top of each guides 230a,b&c can be defined to create sufficient friction for holding the HHP stationary in the tube even when it is left unsupported by the operator. Before inserting the TC 210 into the tube the pushing screw 220 can be rotated clockwise pushing the guides 230a,b&c toward a position that matches the internal opening of the tube allowing the penetration of the TC 210 into the tube. In this position, the distance between the top of each 230a,b&c and the central axis of the TC 210 is substantially equal but smaller than the radios of the tube. The distance can be in between 85% to 95% of the radius of the tube, for example.

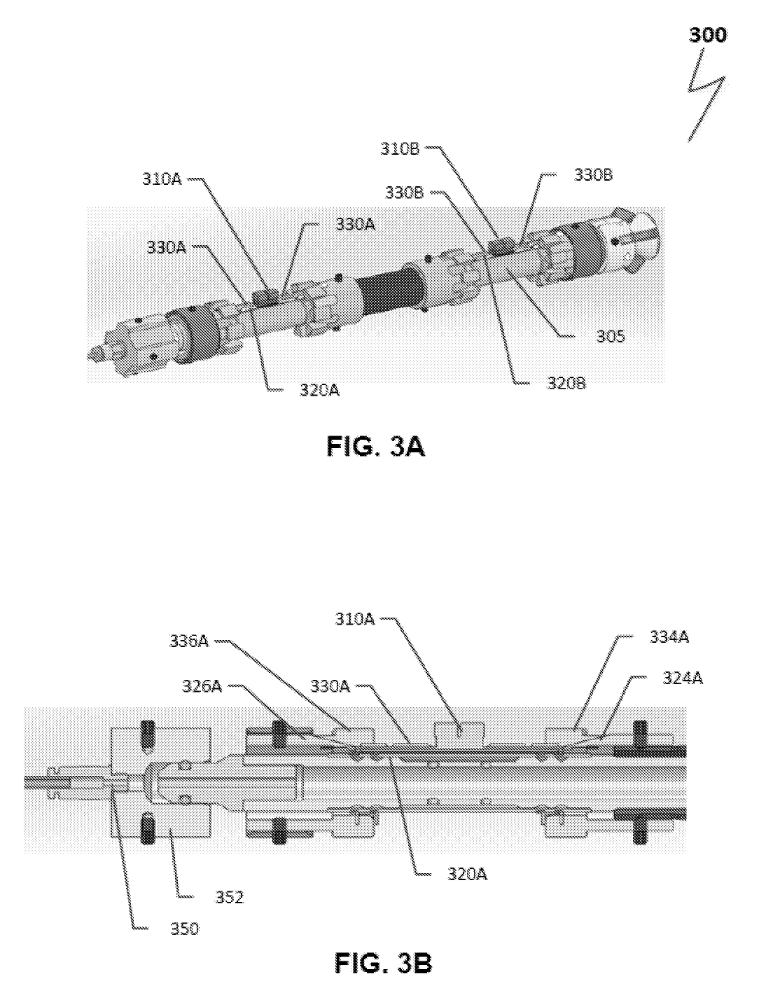

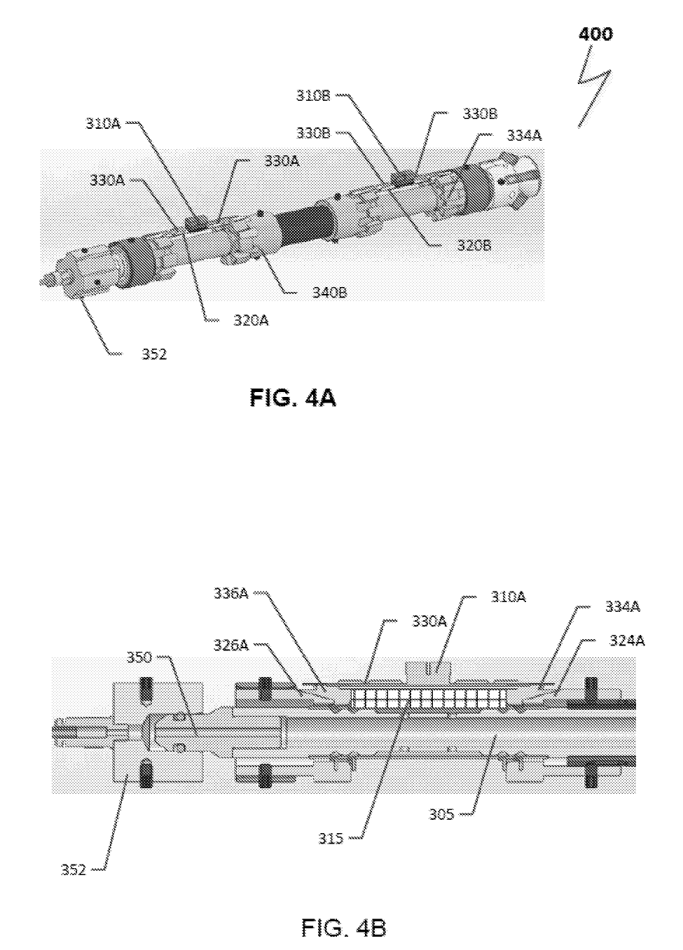

FIGS. 3A&B as well as FIGS. 4A&4B show two states of another embodiment of an ACM that is configured to ensure radial movement of the transducers. FIGS. 3A&B illustrate the non-active state (NAS) 300 and FIGS. 4A&B illustrate the active state ring (ASR) 400 when the TC 400 is inside and be associated with a tube.

The radial movement, of the transducers, maintains the circumferential location of the transducers 310A&B when the TC is associated with the tube. Each transducer 310A&B can be located on a flexible printed circuit 330A&B (respectively) that goes through a rigid U-beam 320A&B, respectively. Each edge of a beam is held in a gear-like mechanism 336A&326A as well as 334A&324A with radial slots having parallel walls and sloped shoulders 326A&324A. In some embodiments in which the U-beam moves in and out, it is constrained to move only in the radial direction. In some embodiments a locking mechanism can be located at the far end of the entire TC 300 a locking mechanism is illustrated 350 and 352 for securing the elements of TC 300 at their place.

In some embodiments, each one of the gaps: between 320A and the main body 305 as well as the gap between 320B and the main body 305 can comprise an elevating mechanism 315 (FIG. 4B). The elevating mechanism 315 can be configured to cause the rigid U-beam 320A&B to move up (far from the main body 305), as it is illustrated by FIGS. 4A and 4B, increasing the diameter of the virtual ring of the transducers 310A&B, as illustrated by FIGS. 4A&B, in order to push the transducers 310A&B toward the internal walls of a tube into an active state.

In some embodiment of the present disclosure, the elevating mechanism 315 (FIG. 4B) can comprises a balloon having a shape of a ring located between the virtual ring of the transducers 310A&B and the main body 305. In some embodiments, a feedback mechanism can be associated with the elevating mechanism. The feedback mechanism can be used to detect that the ring of the transducers matches the internal diameter of the tube. An example of such a feedback mechanism can monitor the pressure that exists in the balloon while the transducers are pushed toward the tube walls.

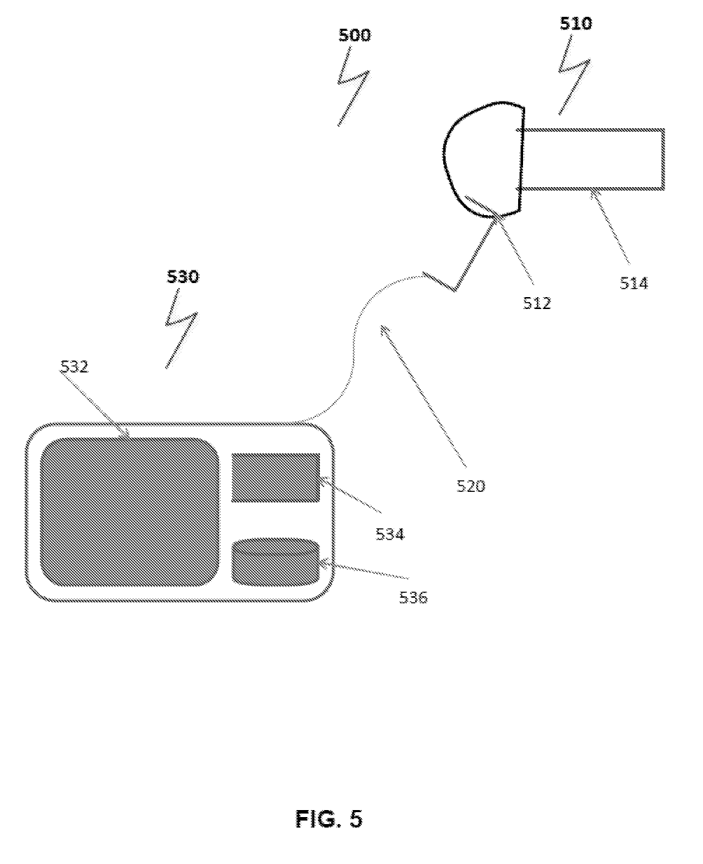

FIG. 5 shows relevant elements of an example of a tube inspection system 500. System 500 may comprise an HHP 510 having a housing 512 and a TC 514, a main processing unit (MPU) 530 and a cable 520 that connects the HHP 510 and the MPU 526. In some embodiments the TC 514 can be a removable TC 514, which can be replaced with another TC 514 having a different diameter. The appropriate TC 514 can be selected according to the internal diameter of a tube to be inspected next.

In more detail, the housing 512 is used to insert the transducer cylinder 514 into the interior of a tube under inspection. Next, an example of an adjustable centering mechanism (ACM) can be activated in order to push the virtual ring of the transducers toward the wall of the tubes. As results of elevating the transducers, from the main body 305, the TC can be associated with the internal surface of inspected tube holding the HHP at its position. In some embodiments the ACM can be the one that is illustrated in FIGS. 2A&B. Other embodiments of HHP 510 may have the ACM that is illustrated in FIGS. 3A&B and FIGS. 4A&B.

After pushing the virtual ring, of the transducers, toward the wall, a sequence of measurements can be initiated. One or more of transducers 310A on the first virtual ring can serve as actuators that function to create the mechanical GW, while the transducers 310B on the other ring serve as receivers, for example. All received mechanical signals are converted into electronic signals by the one or more transducers 310B of the second ring. The electronic signals can be transmitted or communicated to the main processing unit (MPU 530), via cable 520, where they can be processed and stored.

In some embodiments, a detachable transducer cylinder 514 can have a shape of a cylinder with a near end and a far end. The external diameter of the cylinder 514 is less than the internal diameter (ID) of the tube under inspection. The near end of the detachable transducer cylinder 12 can comprise an example of the conical-centering mechanism (CCM) 130 (FIGS. 1A,B & C). The illustrated example of the CCM 130 comprises one or more stepwise conical elements 132, 134, 136, 138 & 139 (FIGS. 1B&C) at the near end of the TC 514 that is attached to the body 512 of the HHP 510. A plurality of detachable transducer cylinders can be associated with the HHP 510. Each detachable transducer cylinder 514 can relate to a certain range of diameters of an inspected tube.

The MPU 530 can generate and transmit, via the cable 520, the electrical excitation signals toward the GW elements (transducer 310A&B in FIGS. 3A&B and FIGS. 4A&B, for example). The received electronic signals from the transducers can be carried over cable 520 toward the MPU 530 in order to be processed and stored.

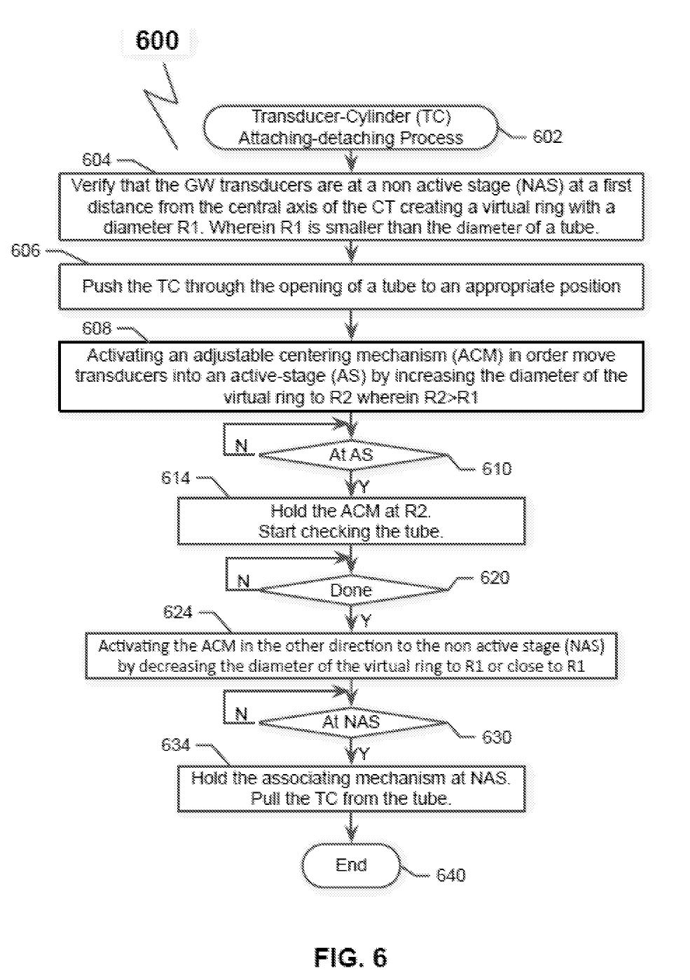

In some embodiments, the cable 520 can comprise pressure and/or vacuum lines for pressing mechanism ACM 200 or the leading screw 350 to be actuated and thus press the transducers 310A&B against the interior wall of the tube under inspection. The MPU 530 may comprise a storage medium 536 for recording the signals, software, reports, etc. In addition, the MPU 530 may comprise a processor 534. The processor 534 can be loaded from the storage medium 536 with software to execute the necessary processes for measuring the condition of the inspected tube, collecting the obtained signals, processing them, analyzing them, and delivering reports or output information to a display 532, for example. An example of such a process is disclosed below in conjunction with FIG. 6. The display unit 532 can be used as an interface between a user and the MPU 530. In addition MPU 530 can be connected to a printer (not shown in the drawings) in order to deliver printed reports.

Referring now to FIG. 6, which illustrates a flowchart with relevant actions of an example attaching-detaching process 600 of an example of a TC 120 of a HHP 100 (FIG. 1) with a tube under test. Process 600 can be implemented by a main-processing unit (MPU) 530 that mange the tube inspection process. The process can be initiated 602 by a user after associating an appropriate transducer cylinder 514 with the housing 512 of the HHP 510 (FIG. 5). The user can load the MPU 530 with information about the inspected tube (not shown in the figures), the transducer cylinder 514 (FIG. 5), the bundle (if the tube is in a bundle of tubes), etc. The information about the tube can comprise: the internal radius, external radius, length, material, etc. The information about the transducer cylinder 514 can include: number of transducers rings, 310A&B; number of transducers on each ring, etc.

In some embodiments of the HHP 510 (FIG. 5), the interface between the transducer cylinder 514 and the housing 512 can include an indicator that indicates the number of rings and the number of transducers on each ring. The indicator can be electrical switches that can be set according to the configuration of the cylinder. In alternate embodiments the indictor can be an optical indicator having a combination of holes, or a printed code such as a barcode, a dip-switch, an RFID, a readable memory element, etc. The housing can include a reader that matches the method that was implemented for the indicator and can automatically read and load the configuration of the transducers cylinder 514 to the MPU 530.

After associating the TC 514 and the HHP housing 512, process 600 can verify 604 that the GW transducers 310A&B are at a non-active stage (NAS) as illustrated by FIGS. 3A&B. In some embodiment the verification can be done manually by a human tester (a user). In such embodiment, process 600 can be configured to instruct the user 604 to check if the transducer rings are in NAS and process 600 can wait to get a confirmation from the user. In other embodiment the TC 300 may include location indicators (not shown in the figures). The location indicators can point on the relative location between the transducers 310A&B and the main body 305. An example of location indicator can comprise an air pressure indicator that is configured to monitor the pressure in the balloon of the elevating mechanism 315.

Next at block 606 the TC 514 can be pushed toward the opening of the next tube to be tested. At block 608 the user can be instructed to associate the TC with the tube and to activate the elevating mechanism 315. The elevating mechanism 315 can increases the diameter of the virtual ring of the transducers in order to attach them to the internal wall of the inspected tube.

At block 610, process 600 may wait until the transducers reach the active stage (AS) location. In some embodiment the indication can be obtained from measuring the air pressure in the balloon of the elevating mechanism. In other embodiments, the indication can be obtained from an encoder or a limit switch, etc. Yet in some embodiments the user can check from time to time whether the HHP 510 is caught by the tube or not.

After determining that the TC 514 and the tube are associated, which means that the transducer rings are at an active stage (AS), the tube inspection process can be initiated 614 and mechanical GW can be transmitted toward the tube wall and reflection of the GW from the tube wall can be obtained by the transducers 310A&B. At the end of the tube inspection process 620, the elevating mechanism can be activated 624 in the other direction in order to detach the transducers from the tube wall and reach the NAS.

Next process 600 may wait 630 to obtain an indication that the virtual rings of the transducers 310A&B are in the NAS, which means that the diameter of the VR of the transducers is substantially smaller than the diameter of the tube. The indication can be obtained in a similar way to the indication that is obtained in block 610. Then the elevating mechanism can be hold in it's position, the TC can be pulled out 634 from the inspected tube and process 600 can be terminated 640.

The above description is intended to be illustrative, and not restrictive. For example, the above-described embodiments may be used in combination with each other. Many other embodiments will be apparent to those of skill in the art upon reviewing the above description.

The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein”.

1. A hand-held probe (HHP) for inspecting a tube defining an internal diameter and an interior, the HHP comprising:
a transducer cylinder having a shape of a cylinder with a near end and a far end, the transducer cylinder comprises one or more rings of transducers (TRs), wherein each of the one or more rings of TRs comprises two or more mechanical wave transducers, wherein the transducer cylinder has a diameter that is less than the internal diameter of the tube; and
a housing having an opening for receiving the near end of the transducer cylinder into the interior of the tube under inspection;
wherein the transducer cylinder comprises an adjustable centering mechanism (ACM) that is configured to join substantially a central axis of the transducer cylinder with a central axis of the inspected tube when the transducer cylinder is inside one end of the inspected tube.

2. The HHP of claim 1, wherein the ACM comprises a conical-centering mechanism (CCM) at the near end of the transducer cylinder.

3. The HHP of claim 2, wherein the CCM comprises a plurality of stepwise conical elements.

4. The HHP of claim 2, wherein the ACM comprises, at the far end of the transducer cylinder, three or more guides and a pushing screw.

5. The HHP of claim 4, wherein the pushing screw is configured to push the three or more guides in a radial direction toward a wall of the tube.

6. The HHP of claim 1, wherein each of the one or more rings of TRs comprises a flexible beam per each transducer of the relevant TR; and
wherein the flexible beam is configured to carry the relevant transducer thereof in substantially radial movement toward a tube wall or the central axis of the transducer cylinder by an elevating mechanism.

7. The HHP of claim 6, wherein the elevating mechanism is a balloon located between the TR and the central axis of the transducer cylinder.

8. A method for associating a hand-held probe (HHP) for inspecting a tube with the tube, the method comprising:
inserting a transducer cylinder (TC) of the HHP, wherein the TC comprises two or more transducer rings (TR) wherein each of the two or more TRs is associated with a plurality of mechanical wave transducers, wherein the transducer cylinder has a diameter and each of the of the two or more TRs is less than an internal diameter of the tube;
activating an adjustable centering mechanism (ACM) to move each of the transducers of each of the two or more TRs in substantially radial movement toward the tube wall;
executing the tube inspection process;
activating the adjustable centering mechanism (ACM) to move each of the transducers of each of the two or more TRs in substantially radial movement toward a central axis of the TC; and
pulling the TC out of the tube.
